(19) United States
(12) Patent Application Publication
(10) Pub. No.: US 2015/0282916 A1
(43) Pub. Date: Oct. 8, 2015

(54) METHOD, APPARATUS AND KIT FOR ARTIFICIAL INSEMINATION OF BOVINE

(71) Applicant: Brad K. Stroud, Weatherford, TX (US)

(72) Inventor: Brad K. Stroud, Weatherford, TX (US)

(21) Appl. No.: 14/683,701

(22) Filed: Apr. 10, 2015

Related U.S. Application Data
(63) Continuation-in-part of application No. 13/814,458, filed on Jul. 3, 2013.

(51) Int. Cl. A61D 19/02

(52) U.S. Cl. CPC A61D 19/027; A61D 19/024

(57) ABSTRACT

An improved method, apparatus and kit for artificially inseminating a female bovine including a bellows-like container having an opening associated therewith for receiving a solution therewithin, a nozzle member having one end portion engageable with the opening associated with the bellows-like container, a hollow metal pipette having a closed terminal end portion for insertion into the reproductive organs of a female bovine, and a flexible tube member having one end portion engageable with the terminal end portion of the nozzle member and having its opposite end portion engageable with the proximal end portion of the metal pipette. The flexible tubing connecting the nozzle member with the metal pipette allows the bellows-like container to be elevated to a substantially vertical position prior to evacuating the semen/diluent solution from the bellows-like container through the present apparatus to the reproductive organs of a female bovine during the insemination process.

### CROSS-REFERENCE TO RELATED APPLICATIONS

This application is a continuation-in-part application and claims priority to U.S. patent application Ser. No. 13/814,458, filed on Jul. 3, 2013 and entitled “Method and Apparatus to Reduce the Number of Sperm Used in Artificial Insemination of Cattle”, the content of which is hereby incorporated by reference in its entirety.

### BACKGROUND OF THE INVENTION

The present invention relates generally to a method, apparatus and kit for artificial insemination of female bovine and, more particularly, to an improved method, kit and apparatus that includes a bellows-like container, a nozzle engageable with the container and configured to receive a semen straw, a metal pipette for insertion through the cervix and into the uterus of a female bovine, and a flexible tubing for coupling the nozzle with the pipette. The present apparatus offers unique breeding opportunities to cattle breeders worldwide. It is an atraumatic procedure that utilizes novel, but rather simple and inexpensive equipment to more successfully complete artificial insemination in bovine, particularly, young heifers. The present method and apparatus gives the breeder a much needed advantage with respect to passing the pipette through the torturous and difficult to navigate cervix of some female bovine especially young heifers of all breeds and mature cows of breeds composed of Bos Indicus genetics.

Most dairy cattle are bred using conventional artificial insemination (AI) techniques resulting in conception rates of approximately 20%-40%, and most beef cattle conventional AI techniques result in conception rates of approximately 50% to 60%. Frozen semen straws are used in conventional AI techniques, each holding approximately 20 million unsorted sperm. In comparison, a bull in a pasture deposits billions of sperm each time he mates with a cow or a heifer. Further, the bull is not shy about repeatedly mating with a female while she is in heat, further increasing the enormous number of sperm and the large volume of semen in the reproductive system of a female bovine.

Beef cattle are typically bred to produce more males as compared to females since male cattle can be raised to gain more weight in a shorter period of time.

Dairy cattle bulls have been bred to sire females that produce the most milk. These desirable bulls are developed and raised on facilities that are typically referred to in the industry as “Bull Studs”. The dairy industry is very picky about the genetics of the bulls which produce the sperm used in conventional semen straws. The same is true with respect to the beef cattle ranchers. Semen from these desirable bulls is collected at the Bull Studs and packaged in the frozen semen straws for sale to cattle owners, dairy farmers and others. In 2010, there were approximately 25-30 Bull Studs in the U.S. producing frozen semen straws for the dairy and beef industry. Importantly, however, market demand for semen straws from the top bulls exceeds the natural supply. Bulls can only produce so much sperm during the course of a year.

Intuitively, a reduction in the number of sperm in a semen straw would lower conception rates using conventional AI techniques. The present inventor has developed not only the technique to reduce the number of sperm required for impregnation of a female bovine while at least maintaining conception rates comparable to conventional AI techniques (approximately 20-40% in dairy cattle and 50% to 60% in beef cattle), but also improving the chance for successful passage of the pipette through the difficult to navigate cervix of a female bovine, particularly, young heifers. As a result, the Bull Studs may sell the same amount of semen but in more semen straws over time from a single bull with superior genetics. This could allow dairymen and beef cattle breeders to breed more of their cows with sperm from the most desirable bulls.

Some bovine semen is sex sorted. Current sex sorting technology is relatively slow. Therefore, sex-sorted straws contain a fraction of the number of sperm found in a conventional unsorted semen straw. For example, it is current practice to place a minimum of 2.1 million sorted sperm in a straw as compared to 20 million unsorted sperm in a straw. The speed of the sorting process is inversely related to the accuracy of the machine's ability to sort by sex. The faster the machine sorts, the less accurate it becomes in determination of the sex of the semen.

Over the years, the present inventor, Dr. Brad Stroud, DVM has been trying to develop ways to increase conception rates in the dairy and beef industry. Two prior U.S. patent applications filed by Dr. Stroud aim to increase the overall conception rates of beef and dairy cattle: “Artificial Breeding Techniques for Bovines including Semen Diluents and AI Apparatus”, application Ser. No. 11/829,240 filed on Jul. 27, 2007 and “Artificial Breeding Techniques for Bovines Including Semen Diluents and AI Apparatus” application Ser. No. 12/506,723 filed on Jul. 21, 2009. These two prior patent applications used conventional frozen semen straws containing approximately 20 million unsorted sperm and sex sorted semen straws containing either 2.1 million or 5 million sperm and disclose a disposable syringe connected to an elongate plastic pipette. The plastic pipette must be rigid enough and have a small enough outer diameter (OD) to allow a technician to guide it through the three rings of the cervix, which requires a skilled bovine AI technician, especially in the case of a heifer which has much smaller cervical rings than a mature cow. Without a small OD and enough stiffness in the plastic pipette, the technician a) may lose his/her ability to properly guide the pipette and potentially injure a valuable animal, b) can also result in incorrect placement of the semen in the reproductive tract and/or c) may also lose the ability to pass the pipette through the cervix. Production of an elongate plastic pipette with the necessary small OD and rigidity to easily and automatically pass through the female's cervix has been problematic. The present invention uses, among other things, a metal pipette which does have sufficient stiffness along with a small enough OD to allow a technician to help guide the device through the three rings of the cervix of the bovine's reproductive organs without injury to the bovine or unnecessary delay in the procedure, or even failure to pass through the tortuous cervical rings and not the uterus. The current invention also eliminates the use of syringes and uses a bellows-like container which is shorter than a typical syringe and is much easier for a technician to handle and manipulate during the insemination process. Neither of these two prior patent applications addressed the shortage of sperm from desirable bulls. These two prior patent applications are directed to increase conventional conception rates of cattle that have been artificially inseminated using the methods disclosed therein.

In contrast, application Ser. No. 13/814,458 entitled “Method and Apparatus to Reduce the Number of Sperm Used in Artificial Insemination of Cattle”, also filed by Dr. Stroud on Jul. 3, 2013, does not promise increased conception rates. Instead, this invention offers conception rates that are at least comparable to conventional AI techniques using less sperm. This invention will significantly reduce the number of sperm from desirable bulls used in each semen straw, allowing more cows to take advantage of a precious resource that is limited by natural production. Although Dr. Stroud's previous applications disclose improvements over the methods and apparatus discussed in each of his previous applications, the present method and apparatus provide still further advantages as discussed below.

Conventional artificial insemination devices are well known to those skilled in the art and conventional AI devices including the devices disclosed in Dr. Stroud's previous applications all include a syringe or plunger-type mechanism sliding inside a hollow barrel or pipette, some use a disposable plastic sheath, and some use a balloon catheter, multiple syringes, and an illuminated vagina speculum to facilitate insertion of the AI device into the bovine's reproductive organs. Although all of the known conventional AI devices have attempted to address certain difficulties associated with artificial insemination of bovines as well as improving the successful insemination rate, conventional AI devices still suffer from certain disadvantages including the use of syringes which are not always non-toxic to bovine semen. The present invention is directed to an improved method and apparatus as well as a kit which offers a more superior solution to breeders for improving not only the success rate of artificially inseminating bovine, particularly, young heifers, but it also provides the much needed advantage with respect to passing the AI device through the torturous and difficult to navigate cervix of some female bovine especially young heifers.

### SUMMARY OF THE INVENTION

The present invention is directed to a method, apparatus and a kit for artificially inseminating bovine wherein the apparatus includes three or four physical components, namely, a (1) bellows-like container, (2) a nozzle for coupling to the bellows-like container (the nozzle could be integrally formed with the bellows-like container), (3) a stainless steel pipette, and (4) a flexible tubing for coupling the stainless steel pipette to the nozzle of the bellows-like container. More particularly, the first component of the present breeding apparatus is a non-toxic low density polyethylene (LDPE) bellows-like container that preferably holds 30 ML of fluid and/or air. Compared to a syringe, most of which are toxic to bovine sperm, the present bellow-like container is virtually non-toxic to bovine sperm making it suitable for storage after filling as will be hereinafter further explained. The present bellows container is significantly shorter (2.5 inches long) when filled than a filled syringe (8 inches long) which makes it easier to handle for the technician during breeding. Also, due to the ribs associated with the bellows-like container, there is more surface area which makes it faster to warm up than a straight walled syringe. The soft low density polyethylene (LDPE) makes it very easy to push and evacuate the contents from the bellows vessel when inseminating. One end portion of the bellows container includes a cavity or opening adapted for coupling to the second component of the present apparatus, namely, the nozzle.

The present nozzle is made of a hard plastic such as a medium density polyethylene material (MDPE) having one end portion that is configured to cooperatively engage or snap into the female cavity associated with the bellows-like container. The nozzle also includes a cap that engages the distal end of the nozzle for preventing spilling of any contents stored within the bellows-like container during shipment or storage. The cap can be engaged to the nozzle using any known means such as a snap-on, friction or threaded engagement. The present nozzle has an internal lumen or inner diameter that accommodates both half and quarter ML semen straws. The bottom or proximal end of the nozzle may include an optional grate or stop member that acts as a stop so that a thawed semen straw cannot come into contact with any diluent contained in the bellows container. Once semen is placed into the bellows container with a diluent, the nozzle then easily slides into the proximal end of a flexible tube which is attached thereto as will be hereinafter explained.

The third component of the present apparatus includes a stainless steel pipette having a much smaller outer diameter as compared to conventional or standard insemination pipettes used in the AI industry thereby giving the breeder a much needed advantage with respect to passing the stainless steel pipette through the tortuous and difficult to navigate cervix of some female bovines, especially young heifers of all breeds, mature cows of breeds composed of Bos Indicus genetics, and some mature cows of all breeds including dairy cows. The present pipette has a smooth rounded terminal end portion for better penetrating the cervix of a female bovine and at least one transverse outlet port for allowing the semen/diluent to exit the pipette into the reproductive organs of the female bovine. The advantages of the metal pipette, rounded terminal end portion and transverse outlet port will be hereinafter further explained.

The fourth component of the present apparatus includes a flexible silicone tubing which may come pre-attached to the stainless steel pipette and autoclaved. A secure attachment of the silicone tubing to both the nozzle member and the stainless steel pipette is essential. The properties and physical dimensions of the silicone tubing allows for easy connection to both the nozzle member and the metal pipette and it provides for a secured attachment thereto once in place. To assist in the attachment to the metal pipette, the proximal end of the stainless steel pipette may include an added brass or plastic collet, or one or more raised projections or ridges, over which the silicone tubing is stretched, the collet or projection(s) or ridge(s) facilitating holding of the flexible tube tightly in place on the stainless steel pipette. The opposite end of the flexible tubing is attached to the terminal end portion of the nozzle when the overall apparatus is ready for use as will be hereinafter further explained.

It is recognized and anticipated that the present nozzle can be integrally formed with the bellows-like container and it is further contemplated that the optional stop member associated with the present nozzle can likewise be located within the female cavity of the bellows-like container.

The present method for using the present apparatus includes providing a diluent within the bellows-like container and thereafter inserting a semen straw into the present nozzle for incorporating and mixing the semen associated with the semen straw with the diluent present in the bellows-like container. Once the semen has been properly mixed with the diluent in the bellows-like container, the flexible tubing is coupled to both the distal end of the present nozzle and the proximal end of the stainless steel pipette. At this point, the present apparatus is ready for insertion into a female bovine. Once the stainless steel pipette is properly inserted through the cervix of the female bovine, the bellows-like container is then rotated to an elevated position relative to the pipette as will be hereinafter further explained. This elevated positioning of the bellows-like container helps to clear the pipette of the semen/diluent mix and substantially reduces the amount of residual semen left in the pipette after the insemination process is complete as will likewise be hereinafter further explained. Use of the flexible tubing between the present nozzle and the stainless steel pipette enables rotation of the bellows-like container to its elevated, vertical positioning as just described.

Still further, it is anticipated that the present apparatus can be provided in kit form wherein a diluent is pre-loaded into the bellows-like container and a cap is positioned on the present nozzle which is coupled to the bellows-like container so as to contain the diluent within the bellows-like container during shipment and storage. The kit will also include a stainless steel pipette as will be hereinafter further explained along with the flexible tubing. One end portion of the flexible tubing can be pre-attached to the proximal end of the stainless steel pipette and, once the semen from a semen straw has been mixed with the diluent contained within the bellows-like container, the opposite end portion of the flexible tubing can be coupled to the terminal end portion of the present nozzle thereby completing the assembly of the present apparatus. Once assembled, the present apparatus is ready for use in artificially inseminating a female bovine as will be hereinafter further explained.

### BRIEF DESCRIPTION OF THE DRAWINGS

FIG. 1 is a side elevational view of the present apparatus for artificially inseminating a female bovine with all of its component parts fully assembled.

FIG. 2 is a side elevational exploded view of the apparatus of FIG. 1 showing all of its component parts prior to assembly.

FIG. 2A is an enlarged cross-sectional view of the terminal end portion of the present pipette taken along line 2A-2A of FIG. 2.

FIG. 3 is a side elevational view of one embodiment of the present bellows-like container of FIGS. 1 and 2.

FIG. 4 is a partial cross-sectional view of the neck portion of the bellows-like container of FIG. 3.

FIG. 5 is a side elevational view of the nozzle member of FIGS. 1 and 2.

FIG. 6 is a cross-sectional view of FIG. 5 taken along line 6-6.

FIG. 7 is a side elevational view of the bellows-like container and nozzle member of FIGS. 1-6 shown in their assembled condition with a cap member positioned for engaging the terminal end portion of the nozzle member.

### DETAILED DESCRIPTION OF THE INVENTION

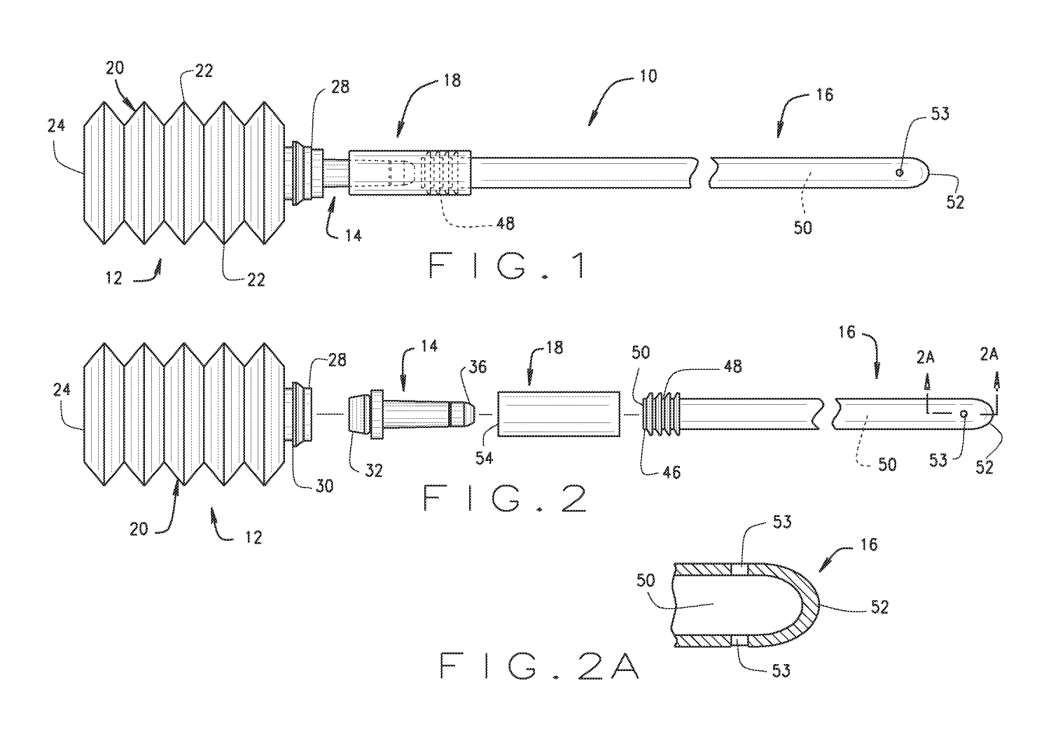

Referring to the drawings more particularly, wherein like numerals refer to like parts, FIGS. 1 and 2 disclose one embodiment of the present AI apparatus 10 which includes a bellows-like container 12, a nozzle 14, a stainless steel pipette 16, and a flexible connection tube 18 for operatively connecting the nozzle 14 to the pipette 16. FIG. 1 illustrates the present apparatus 10 in its fully assembled operative condition whereas FIG. 2 illustrates an exploded view of the various components forming the present apparatus 10.

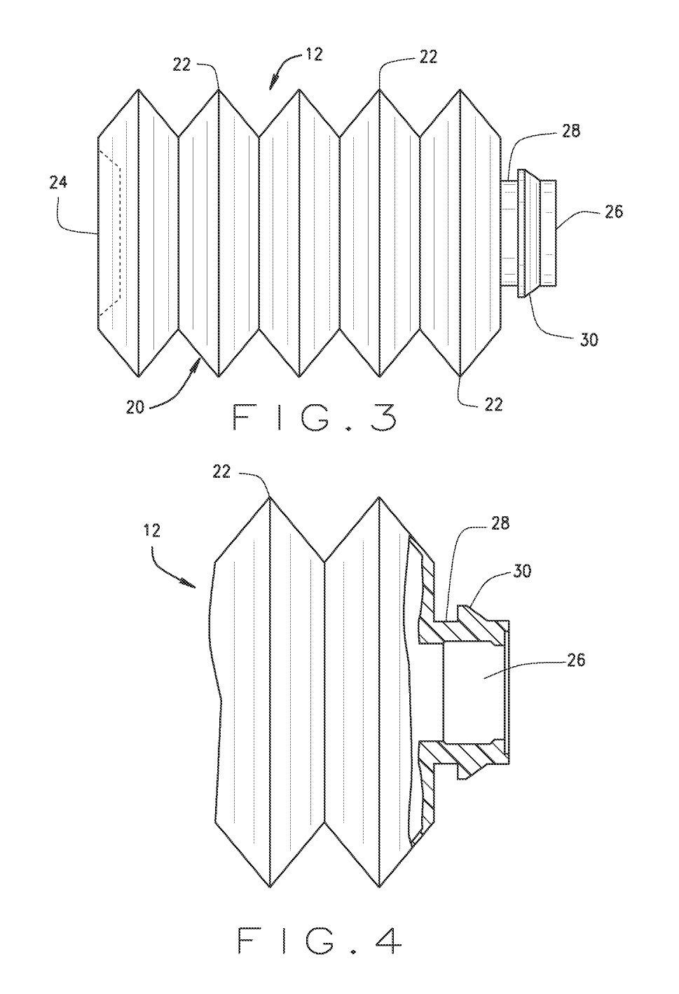

As best illustrated in FIGS. 3 and 4, the present bellows-like container 12 includes a container body 20 formed with a plurality of ridges 22 thereby forming its bellows-like shape. The container body 20 includes a closed wall structure 24 at one end portion thereof and an open female cavity 26 at its opposite end portion. The female cavity 26 includes a neck portion 28 having an outer flange 30 associated therewith, the neck portion 28 being sized and shaped so as to cooperatively receive one end portion of the nozzle member 14 as will be hereinafter further explained. The flange 30 extends angularly outward from the neck portion 28 towards the opposite end portion of the container 12 as best shown in FIG. 4. The bellows-like container 12 is fabricated from a non-toxic low density polytethylene (LDPE) material. Although the container 12 can be made in any size, it is typically made so as to hold either 30 milliliters (ML) of a combination of semen, diluent and air (approximately 2.5 ML) for mature cows or 18 ML of a combination of semen, diluent and air (approximately 2.5 ML) for heifers as will be hereinafter further explained. Other sizes are likewise contemplated and anticipated. The ridges 22 as well as the material forming the container 20 make it easier for a technician to grasp and squeeze or compress the container to evacuate the contents of the container during an artificial insemination process. As will be hereinafter further explained, the air trapped in the container 20 during an AI procedure also helps to clear out any residual semen/diluent mix that typically would remain in the pipette after the semen/diluent mix has been injected into the bovine. The overall length of the bellows container 20 is shorter (2.5 inches) than the conventional syringe (8 inches) used with many of the prior art AI devices which makes it much easier to handle for the technician during the breeding process.

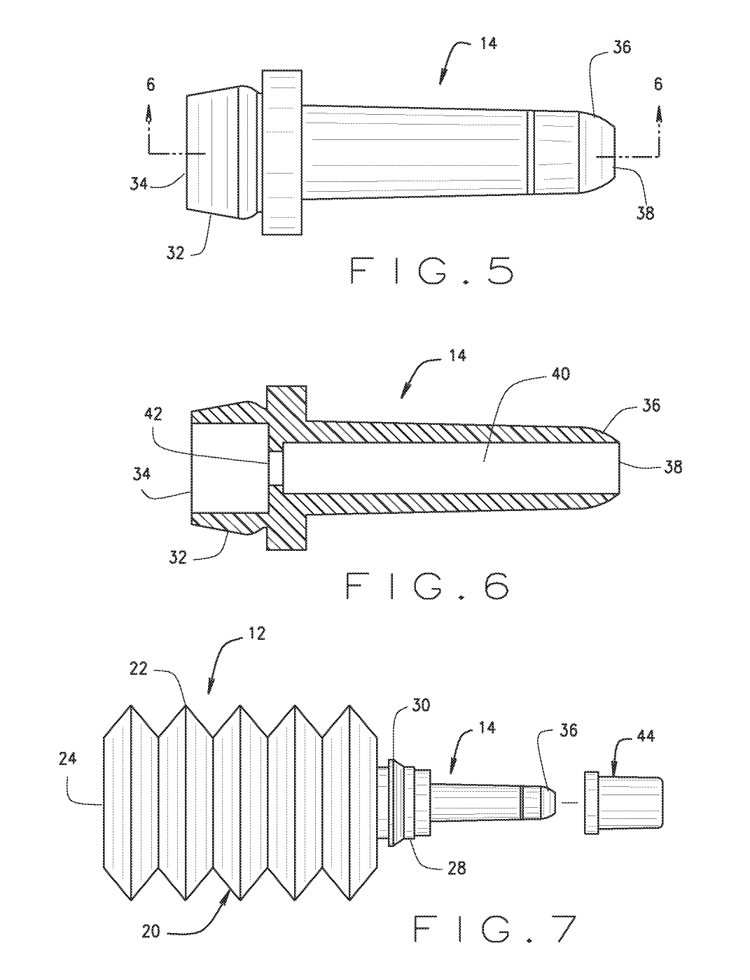

FIGS. 5 and 6 illustrate one embodiment of a nozzle member 14 which is attached to the female cavity 26 of the bellows-like container 12 illustrated in FIGS. 3 and 4. The nozzle 14 includes a proximal end portion 32 having an opening 34 associated therewith, a terminal end portion 36 having an opening 38 associated therewith, and a passageway 40 extending completely therethrough in communication with the respective openings 34 and 38 so that fluid stored within the bellows-like container 12 can be evacuated from the container 20 through the nozzle passageway 40 as will be hereinafter further explained. The proximal end portion 32 is sized and shaped so as to be inserted within the cavity or opening 26 of container 12 and may include a taper as shown in FIG. 5 to allow for easier insertion of the proximal end portion into the bellows-like container opening 26. This connection can be affected by various methods and elements known by a person of ordinary skill in the art such as by a friction fit or snap-on connection.

FIG. 7 illustrates the nozzle member 14 operatively connected to the bellows-like container 12. As best illustrated in FIG. 6, the nozzle member 14 may optionally include a stop member 42 in the form of a grate or other mesh-type member which extends across the proximal opening 34 at a location spaced from its proximal end portion. The stop member 42 includes at least one opening or passageway for allowing the semen contained within a semen straw to follow therethrough as will be hereinafter explained and it functions to stop the end portion of a semen straw inserted within the nozzle 14 such that the semen straw does not make contact with the diluent or other fluid within the container 12 so as not to contaminate such fluid or diluent. In this regard, the terminal end opening 38 as well as nozzle passageway 40 extending therethrough should be of sufficient size so as to accept the insertion of any type of semen straw including both one-half and one-quarter ML semen straws as will be hereinafter further explained. The passageways 38 and 40 have an internal diameter of at least 0.130 inches so as to accommodate both one-half and one-quarter ML semen straws. Once semen from the semen straw is placed into the bellows-like container 12 with the diluent, the semen straw can be easily extracted from the nozzle passageway.

In one embodiment, the nozzle 14 is made from a hard plastic such as a medium density polyethylene material (MDPE) and is approximately 1.080 inches long. The terminal end portion of the nozzle 14 may also include a cap 44 as best shown in FIG. 7 that can be utilized to prevent spillage of any fluid or diluent stored within the container 12 during storage or shipment. The cap 44 can be engaged to the terminal end portion of the nozzle 14 via a self-threading cap, a snap-on mechanism, a friction fit or any other suitable engagement means. Although the bellows-like container 12 is disclosed as having a female cavity 26 associated therewith and the nozzle member 14 is disclosed as having a male proximal end portion 32 associated therewith for insertion into the cavity or opening 26, it is recognized and anticipated that this connection can be reversed with the nozzle member 14 possessing the female connector and the bellows-like container 12 possessing the male connector.

It is also recognized and anticipated that the nozzle member 14 can be made integral with the bellows-like container 12 such that both the container 12 and the nozzle 14 would be a single unit as illustrated in FIG. 7. It is also recognized and anticipated that the optional stop member 42 associated with nozzle member 14 could likewise be incorporated into the container cavity 26 so long as the stop member 42 is positioned and located such that the one end portion of the semen straw inserted through the nozzle passageway 40 cannot come into contact with the diluent stored within the bellows-like container 12.

The stainless steel hollow, elongate pipette 16 is best illustrated in FIGS. 1 and 2 and, in one embodiment, is about 17 inches long with an outer diameter of about 0.135 inches and an inner diameter of about 0.1 inches. Compared to standard artificial insemination pipettes used in the AI industry wherein the outer diameter of such pipettes are typically about 0.185 inches, the much smaller outer diameter of the present pipette gives the breeder a much needed advantage with respect to the passing of the present pipette 16 through the tortuous and difficult to navigate cervix of some female bovines, especially young heifers. As best illustrated in FIG. 2, the proximal end portion 46 of pipette 16 may include a collet or one or more raised projections or ridges 48 for reasons which will be hereinafter further explained. The pipette 16 includes a passageway 50 extending completely therethrough from the proximal end 46 and terminates at its closed terminal end 52. The closed terminal end 52 of pipette 16 is smooth and rounded or tapered so as to further facilitate the passing of the pipette 16 through the tortuous and difficult to navigate cervix of some female bovines, especially young heifers. The closed terminal end portion 52 of pipette 16 also allows the AI technician to more easily maneuver and manipulate the end 52 of pipette 16 through the three rings of the cervix; it allows wedging; and it helps prevent fecal matter typically present in the posterior vagina of a female bovine from entering the pipette. At least one and preferably a pair of transverse outlet ports 53 are located near the terminal end 52 of pipette 16 for allowing the insemination solution (semen/diluent) to exit the pipette into the reproductive organs of the bovine.

The present stainless steel or metal pipette 16 has advantages over the conventional plastic pipettes typically used by the Applicant in that a metal pipette is much more rigid as compared to a conventional plastic pipette and is less likely to bend, flex or twist during insertion through the cervix of a female bovine and is therefore more easily maneuvered through the three cervical rings and the reproductive organs of the bovine. In addition, a metal pipette has less friction and will more easily glides through the tissue associated with the cervix of a female bovine whereas a plastic pipette has more friction and typically does not glide and can cause inflammation and/or bleeding of the cervix even during the insertion process. In addition, a metal pipette can be machined to a much smaller outside diameter as compared to a plastic pipette and still maintain its rigidity. Still further, the closed smooth, rounded terminal end portion 52 of the present pipette again facilitates insertion of the pipette through the reproductive organs of a female bovine and it likewise helps to prevent any fecal matter that may reside in the posterior vagina of a female bovine from entering the pipette and contaminating the semen/diluent solution passing therethrough. Traditional AI pipettes have an open distal or terminal end which can collect fecal matter and which, when forced to pass the cervical rings, can cause inflammation, bleeding and/or other injury to the cervix during the insertion process. In this regard, the transverse or side positioned outlet ports 53 are less likely to pick up and carry fecal matter and fecal bacteria during the insertion process. The smaller outside diameter associated with the present pipette further facilitates the insertion process. Although a stainless steel pipette is presently preferred, it is recognized and anticipated that any metal yielding the above-advantages can be used in fabricating the present pipette 16.

The proximal end 46 of the pipette 16 is connected to the terminal end portion 36 of the nozzle member 14 through the use of a flexible tubing 18. This flexible tubing can be made from silicone and it can have a dimension of about 1.10 inches in length with an inner diameter of about 3/16 inches and an outer diameter of about 5/16 inches and with a wall thickness of about 1/16 inches. The flexible tubing 18 includes a passageway 54 extending completely therethrough. The connection of both opposite end portions of the flexible tubing 18 with the respective end portions of the nozzle member 14 and pipette 16 can be affected by various methods and elements known by a person of ordinary skill in the art. In one embodiment, the respective opposite end portions of the flexible tubing 18 extends over the distal opening 38 of the nozzle member 14 and the inner diameter of the tubing 18 is sized such that it results in a friction fit with the terminal end portion 36 of nozzle member 14. In similar fashion, the opposite end portion of the flexible tubing 18 extends over the proximal end 46 of the pipette 16. Again, this connection can be affected by various methods and elements known by a person of ordinary skill in the art.

In the particular embodiment illustrated in FIGS. 1 and 2, the flexible tubing 18 fits over a collet 48 located near the proximal end portion 46 of the pipette 16. The collet 48 could be one or more ridges extending either partially or fully around the outer-surface of the proximal end portion 46 of pipette 16 as best illustrated in FIG. 2, or the collet 48 could be one or more raised projections or bumps positioned on the outer surface of the pipette end portion 46, or any other surface feature or texture which will improve the attachment of the flexible tube 18 to the proximal end portion 46 of the pipette 16. In one embodiment, the collet 48 can be made of brass having an overall length of about 0.25 inches and having an outer diameter of about 0.25 inches. The presence of the collet 48, or one or more projections or ridges, on the proximal end 46 of the metal pipette 16 provides a tighter friction fit when the flexible tubing 18 is maneuvered over the collet 48. In another embodiment, a zip tie (not shown) can be used to tie and connect the opposite end portions of the flexible tubing 18 to the respective end portions of the nozzle member 14 and pipette 16. It is also preferred that the terminal end portion 36 of the nozzle member 14 lie adjacent to the proximal end portion 46 of the pipette 16 when the members 14 and 16 are connected together with the flexible tube 18 thereby ensuring that all, or at least most, of the semen/diluent solution passes from the nozzle member 14 to the pipette 16. In one embodiment, the flexible tubing is made from silicone and it is a cured silicone tubing capable of withstanding autoclave temperatures in the neighborhood of 250° F. Although other flexible tubing may be utilized, whatever material is selected, it should be able to withstand normal autoclave temperatures without turning opaque, or losing its flexibility and without expanding its outer diameter so as to lose its tight fit on the proximal end of the pipette.

In one embodiment, the bellows-like container has a length from the end wall 24 to the opening 26 of about 2.281 inches (57.95 mm), and the diameter of the bellows-like container 12 at a ridge 22 is about 1.406 inches (35.72 mm). The opening 26 has a diameter of about 0.310 inches (7.87 mm). The length of the neck portion 28 is about 0.281 inches (7.1 mm). The flange is located about 0.187 inches from the terminal end of opening 26 and extends angularly outward from the neck portion 28 at an angle of about 60°. The length between the tip of a ridge 22 to a corresponding valley as measured longitudinally along the length of container 12 is about 0.200 inches (5.08 mm) and the angle formed between two adjacent ridge tips is about 77° when the bellows-like container is depressed or compressed. The one end portion 24 of the bellows-like container 12 may also include an indention towards the inner cavity of the bellows-like container, the depth of the indention measured longitudinally being about 0.125 inches (3.18 mm).

In one embodiment, the diameter of the proximal opening 34 of the nozzle member 14 may be larger than the diameter of the terminal opening 38.

A method of artificially inseminating a female bovine using the present apparatus 10 includes the following steps. First of all, before or after the nozzle 14 is attached to the bellows-like container 12, a diluent is deposited within the bellows-like container 12. The technician may select any of several known diluents for use in the present method including buffered saline, various chemically available embryo flush solutions, various commercially available extenders used in cryopreservation of semen and other products or other solutions not identified herein may also prove useful provided they have a proper pH, Osmolarity and are properly buffered to dilute and support the life of the sperm. The pH of the diluent is typically about 7 to about 7.4 and the Osmolarity is typically about 280 to about 300 mOsm/L.

Various commercially available embryo flush solutions that may be suitable in the practice of the present invention include:

a) Syngro Holding Medium, Vigro Complete Flush Solution, Vigro Holding Plus, Vigro Rinsing Solution all available from Vetoquinol, Fort Worth, Tex. USA.

b) emP3 Complete Flush and emP3 Holding Solution both available from Partnar Animal Health of Port Huron, Mich., (www.partnaranimalhealth.com).

c) Emcare Complete Ultra Flush Medium, available from ICPbio International Ltd. Of Auckland, New Zealand, (www.icpbio.com).

Some extenders used in cryopreservation of bull semen may be used as a diluent in the practice of the present. Other semen extenders such as Biladyl®, Fraction A, also from Minitube of America in Verona, Wis. (www.minitube.com) does not contain a cryoprotectant or glycerol and may be suitable for use in the practice of this invention. The present invention may be practiced with any diluent that is not toxic to bovine sperm or the bovine's reproductive system.

Once the diluent is stored within the bellows-like container 12, the nozzle member 14, if not already attached to the container 12, is thereafter inserted into the female cavity 26 for attachment to the container 12. As previously explained, the bellows-like container 12 typically comes in various sizes and can be fabricated in any size. Typically, a 30 ML container is utilized for mature cows and an 18 ML container is utilized for smaller bovines such as heifers. Typically, a ½ or ML semen straw is used within a 30 ML or an 18 ML. If a 30 ML container is used, typically such container will include 27 ML of diluent, ½ or ¼ ML of semen and 2½ or 2¾ ML of air. If an 18 ML container is utilized, typically such container will include 15 ML of diluent, ½ or ¼ ML of semen and 2½ or 2¾ ML of air.

Once the diluent is transferred to the bellows-like container 12, the appropriate sized semen straw is selected and inserted into the terminal end portion of the nozzle member 14. Typically, the semen straw is kept frozen until ready for use. The semen straw includes a cotton plug on one end and a crimp on the other end. The semen is frozen between the crimped end and the cotton plugged end of the semen straw. Prior to inserting the semen straw into the nozzle member 14, a technician will warm the frozen semen straw in warm water at a temperature of about 95° F. to about 98° F. for at least about 30 seconds. Once the semen is thawed, the crimped end of the semen straw is cut and the cut end is placed within the nozzle openings 38 and 40. In one embodiment, the nozzle member 14 and/or the bellows-like container 12 will not include the optional stop member 42. In this embodiment, the crimped end of the semen straw will have to be sanitized with a moist alcohol wipe prior to cutting the crimped end of the straw. Once the crimped end has been sanitized, the crimped end of the semen straw is cut and inserted into the nozzle opening 38 and the semen straw is pushed through the nozzle 14 so that the cut end of the semen straw will rest against the closed end wall 24 of the bellows-like container. In this embodiment, the bottom of the bellows-like container functions as a stop member. Once so positioned, the cotton plug is then pushed along the length of the semen straw with a stylette or other appropriate instrument thereby forcing the semen through the straw into the diluent contained with the container 12. In this regard, it is advantageous to cut the semen straw at an angle, preferably at an angle of about 45°, so that the evacuation of the semen from the semen straw will flow easily into the bottom of the bellows-like container 12. If, for example, the crimped end of the semen straw is cut transversely across such end portion at a 90° angle, when the cut end of the semen straw is positioned against the closed wall end 24 of the bellows-like container, the wall 24 will interfere with and block the steady flow of semen from the straw into the container 12. As a result, an angular cut is preferred although not required. If a 90° cut is utilized, the cut end of the semen straw can be spaced slightly from the closed end wall 24 of the bellows-like container when that semen straw is positioned within such container.

In another embodiment where stop member 42 is utilized within either the nozzle 14, or within the container cavity 26, although preferred, there will be no need to sanitize the crimped end of the straw prior to cutting such crimped end because the crimped end of the semen straw will be positioned within the nozzle opening 38 such that it will make contact with and abut the stop member 42 within the nozzle member 14. As such, the cut end of the semen straw will not make contact with the diluent and will not contaminate such diluent. Once so positioned, the cotton plug is then again pushed along the length of the semen straw with a stylette or other appropriate instrument so as to force the semen to drain from the straw into the diluent contained within the container 12. The stop member 42 also stops the progression of the cotton plug as it pushes the semen through the semen straw. Whether the optional stop member 42 is utilized or not, once the semen is evacuated into the diluent contained within the bellows-like container 12, gently swirling of the bellows-like container will mix the semen with the diluent.

In an alternative method for evacuating the semen associated with a semen straw into the diluent, the cotton plug associated with a typical semen straw can be removed by cutting and the semen can be allowed to drain by gravity into the diluent via the container cavity 26.

Once the semen is thoroughly mixed with the diluent within the bellows-like container 12, one end portion of the flexible tubing 18 is positioned over the terminal end portion 36 of the nozzle member 14. In similar fashion, the opposite end portion of the flexible tubing is then positioned over the proximal end 46 of the pipette 16 and over the collet 48, if the collet is used, so as to couple the pipette 16 with the container 12 and nozzle 14. The present AI apparatus 10 is now fully assembled and is fully operable for insertion into the reproductive organs of a female bovine and for evacuating the semen/diluent mix into the bovine.

Because the metal pipette 16 is rigid and much smaller than conventional AI pipettes presently in use, manipulation of the pipette 16 into the bovine's vagina, past the three rings of the cervix to the body of the uterus is more easily accomplished, particularly when inserting the pipette 16 into the reproductive organs of a heifer. The present stainless steel pipette 16 is easier to insert and glides through the cervix of even a heifer due to its rigidity and size as compared to conventional plastic pipettes. The metal pipette 16 with its closed, smooth, rounded terminal end 52 acts as an atraumatic aid in passing through the tortuous cervix. Once the pipette 16 is properly inserted within a bovine, a technician will rotate the bellows-like container 12 into a vertical position before depressing or compressing the bellows container 12 to flush or evacuate the semen/diluent mix through the apparatus 10 to the uterus of the bovine. When the bellows container 12 is rotated into a vertical position, the semen/diluent is moved towards the opening 26 of the container preparatory to evacuating the semen/diluent mix through the nozzle member 14, the tube 18 and the pipette 16. The air trapped within the bellows container, when in its vertical position, moves to the top of the end wall 24 of the container 12 and facilitates the clearing of the line and the discharge of the semen/diluent solution through the nozzle 14, the flexible tubing 18 and the pipette 16 when the container 12 is depressed or compressed.

A typical pipette will hold about 2.5 ML of the semen/diluent solution along its length. Trapping about 2.5 ML of air at the top of the vertically oriented container 12 is just enough air to clear the pipette of any residual semen/diluent mix. The 2.5 ML of air is the last thing to exit the bellows-like container 12 thus pushing and clearing the nozzle 14, flexible tube 18 and pipette 16 of any residual mix. If this air was not present in the system, we would lose the volume of semen/diluent mix which would remain in the pipette. This is approximately 2.5 ML or 8% of the total volume. The flexible tubing 18 allows the bellows container 12 to be rotated into its vertical position before flushing the semen/diluent mix through the present apparatus 10. The technician will hold the bellows container 12 depressed until the semen/diluent is deposited within the reproductive organs of the bovine and until the pipette 16 is pulled out of the bovine's cervix.

The present apparatus 10 can also be provided in kit form wherein the various components 12, 14, 16 and 18 can be packaged for use by an AI technician. In one embodiment, the kit can include each of the four components, namely, the bellows-like container 12, the nozzle member 14, the metal pipette 16, and the flexible tubing 18 in a packaged container for use and assembly by the AI technician. In another embodiment, a prescribed amount of diluent can be pre-stored within the bellows container 12 and the nozzle member 14 can be attached thereto, or integrally formed therewith, such that cap member 44 can be engaged with the terminal end portion 36 of the nozzle member 14 so as to prevent spillage of the diluent within the container 12 during storage and shipment as well as possible contamination. The container 12, nozzle 14 and diluent stored within the container 12 along with the cap member 44 can be packaged in a suitable arrangement along with the pipette 16 and flexible tubing 18 for use by an AI technician. In another embodiment, the one end portion of the flexible tubing 18 can be pre-attached to the proximal end portion 46 of the metal pipette 16 and provided to the AI technician along with the container 12, nozzle member 14, cap 44 and diluent stored within the container 12. This kit arrangement, if stored properly, will speed up the artificial insemination process when the AI technician is ready to artificially inseminate a female bovine. The pipette 16 may include a collet 48 located at its proximal end portion 46.

In another kit embodiment, it is recognized and anticipated that the flexible tubing 18 will be placed over the collet 48 or other projection(s) or ridge(s) on the proximal end 46 of the metal pipette 16 before being placed in the kit package. This combination of the flexible tubing 18 already attached to the proximal end 46 of the pipette 16 will then be autoclaved for sanitation purposes and will be placed in the kit ready for use by the AI technician. The bellows-like container 12 will then be pre-filled with diluent and the nozzle 14 will be snapped into place or otherwise engaged with the bellows-like container 12 with a protective cap 44 engaged with the terminal end 36 of the nozzle 14. The combination of container 12 with the diluent pre-stored therewithin, nozzle 14 and cap 44 will then be placed in the kit along with the combined autoclaved pipette 16 and flexible tubing 18. This kit will then contain basically two components as just described. Once a semen straw is thawed and mixed with the diluent in the bellows-like container as previously described, the nozzle will be pushed into the open end of the flexible tubing 18 creating a tight friction attachment therebetween and the AI technician will now be ready to artificially inseminate a female bovine. Other kit arrangements are likewise envisioned and anticipated. Kits can be packaged specifically for use on mature female bovine and kits can be packaged for use on heifers.

Moreover, it is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

Lastly, all defined terms used in the application are intended to be given their broadest reasonable constructions consistent with the definitions provided herein. All undefined terms used in the claims are intended to be given their broadest reasonable

1. An apparatus for artificial insemination of a bovine comprising:
a bellows-like container having an opening associated with one end portion for receiving a solution therewithin;
a nozzle member having a proximal end portion, a terminal end portion, and a passageway extending therebetween, said proximal end portion being configured for engagement with the opening associated with said bellows-like container, said passageway being sized and dimensioned so as to receive at least a portion of a semen straw inserted therewithin from the terminal end portion thereof;
a hollow, elongate metal pipette having a proximal end portion, a closed terminal end portion, a passageway extending therebetween, and at least one transverse outlet port; and
a flexible tube member having a passageway extending therethrough, one end portion of said flexible tube member being engageable with the terminal end portion of said nozzle member, and the opposite end portion of said flexible tube member being engageable with the proximal end portion of said metal pipette.

2. The apparatus defined in claim 1 wherein said bellows-like container is fabricated from a low density polyethylene material.

3. The apparatus defined in claim 1 wherein said nozzle member includes a stop member located near the proximal end portion thereof, said stop member being positioned and located so as to engage one end portion of a semen straw when the semen straw is inserted within said nozzle member so as to prevent the semen straw from contacting a solution contained within said bellows-like container.

4. The apparatus defined in claim 3 wherein said stop member includes at least one opening for allowing the semen contained within a semen straw to flow therethrough.

5. The apparatus defined in claim 1 including a cap member for engagement with the terminal end portion of said nozzle member.

6. The apparatus defined in claim 1 wherein said nozzle member is made from a polyethylene material.

7. The apparatus defined in claim 1 wherein said metal pipette is made from stainless steel.

8. The apparatus defined in claim 1 wherein said flexible tube member is made of silicone.

9. The apparatus defined in claim 1 wherein the proximal end portion of said metal pipette includes a collet, the opposite end portion of said flexible tube member extending over said collet when the opposite end portion of said tube member is engaged with the proximal end portion of said metal pipette.

10. The apparatus defined in claim wherein said flexible tube member is sufficiently flexible so as to allow the bellows-like container to be rotated to a substantially vertical position during the artificial insemination process.

11. The apparatus defined in claim 1 wherein the outer diameter of said metal pipette is about 0.135 inches and the inner diameter of said metal pipette is about 0.1 inches.

12. The apparatus defined in claim 1 wherein said nozzle member is formed integral with said bellows-like container.

13. The apparatus defined in claim 1 wherein the closed terminal end portion of said pipette is smooth and rounded.

14. A kit for holding the components of an apparatus for artificially inseminating bovine, said kit comprising:
a bellows-like container having an opening associated with one end portion thereof for allowing a solution to be deposited within said container,
a nozzle member having a proximal end portion, a terminal end portion, and a passageway extending therethrough, the proximal end portion of said nozzle member being engageable with the opening associated with said bellows-like container, the terminal end portion of said nozzle member being configured so as to accept a semen straw when inserted therewithin;
a metal pipette having a proximal end portion, a closed terminal end portion, a passageway extending therebetween, and at least one transverse outlet port; and
a flexible tube member having one end portion engageable with the terminal end portion of said nozzle member and having its opposite end portion engageable with the proximal end portion of said metal pipette.

15. The kit defined in claim 14 including a cap member configured for engagement with the terminal end portion of said nozzle member.

16. A kit for holding the components forming an apparatus for artificially inseminating bovine, said kit comprising:
a bellows-like container having an opening associated with one end portion thereof for receiving a diluent;
a nozzle member having a proximal end portion, a terminal end portion, and a passageway extending therebetween, the proximal end portion of said nozzle member being engaged with the opening associated with said bellows-like container,
a pre-determined amount of diluent stored within the bellows-like container;
a cap member engageable with the terminal end portion of said nozzle member for containing said diluent within said bellows-like container and preventing spillage and contamination during storage and/or shipment;
a metal pipette having a proximal end portion, a closed terminal end portion, a passageway extending therebetween, and at least one transverse outlet port; and
a flexible tube member having a passageway extending therethrough, one end portion of said tube member being engageable with the terminal end portion of said nozzle member when said cap member is removed therefrom, and the opposite end portion of said tube member being engageable with the proximal end portion of said metal pipette.

17. The kit defined in claim 16 wherein said nozzle member is formed integral with said bellows-like container.

18. The kit defined in claim 16 including a collet located near the proximal end portion of said metal pipette, the opposite end portion of said flexible tube member being positionable over said collet.

19. The kit defined in claim 16 wherein the opposite end portion of said tube member is engaged with the proximal end portion of said metal pipette and said metal pipette attached to said tube member are autoclaved before being placed in said kit.

20. The kit defined in claim 16 including a stop member extending across the passageway associated with the proximal end portion of said nozzle member, said stop member having at least one opening associated therewith for allowing the semen contained within a semen straw to flow therethrough, said stop member further functioning to stop the end portion of a semen straw inserted within said nozzle member such that the semen straw does not make contact with the diluent contained within the bellows-like container.

21. The kit defined in claim 16 including a stop member positioned and located within the opening associated with said bellows-like container, said stop member including at least one passageway for allowing the semen contained within a semen straw to flow therethrough, said stop member further functioning to stop the end portion of a semen straw inserted within said nozzle member such that the semen straw does not make contact with the diluent contained within the bellows-like container.

22. A method for the artificial insemination of a female bovine comprising the following steps:
providing a bellows-like container having an opening associated with one end portion thereof for receiving a diluent and bovine semen therewithin;
filling the bellows-like container with a pre-determined amount of diluent appropriate for artificially inseminating a female bovine;
providing a nozzle member having a proximal end portion, a terminal end portion and a passageway extending therebetween;
attaching the proximal end portion of said nozzle member to the opening associated with said bellows-like container,
thawing bovine semen associated with a particular semen straw for mixing with the diluent contained within said bellows-like container;
inserting the thawed semen straw within the terminal end portion of said nozzle member and evacuating the thawed semen from the semen straw into the diluent housed within the bellows-like container,
withdrawing the semen straw from the nozzle member once the semen is evacuated into the bellows-like container;
mixing the semen with the diluent within the bellows-like container,
providing a metal pipette having a proximal end portion, a closed terminal end portion, a passageway extending therebetween, and at least one transverse outlet port;
providing a flexible tube member;
attaching one end portion of said flexible tube member to the proximal end portion of said metal pipette;
attaching the opposite end portion of said flexible tube member to the terminal end portion of said nozzle member;
inserting the metal pipette into the reproductive organs of a female bovine;
rotating the bellows-like container to a vertical position; and
evacuating the semen/diluent solution contained within said bellows-like container through the nozzle member, said flexible tube member and said metal pipette into the reproductive organs of said female bovine by depressing said bellows-like containert.

23. The method of claim 22 further comprising:
continuing to hold the bellows-like container depressed until the metal pipette is pulled out of the female bovine's reproductive organs.

24. The method disclosed in claim 22 wherein the proximal end portion of said nozzle member includes a stop member for stopping one end portion of a thawed semen straw when the semen straw is inserted into the nozzle member.

25. The method defined in claim 22 wherein the opening associated with the bellows-like container includes a stop member for stopping one end portion of a thawed semen straw when the semen straw is inserted into the nozzle member.

26. The method defined in claim 22 wherein the metal pipette has an outside diameter of about 0.135 inches and an inside diameter of about 0.1 inches.

27. The method defined in claim 22 wherein the proximal end portion of the metal pipette includes a collet, the opposite end portion of said flexible tube member being positioned over the proximal end portion of said pipette and over said collet.

28. The method defined in claim 22 wherein said nozzle member is formed integral with said bellows-like container.
